(19) United States
(12) Patent Application Publication
(10) Pub. No.: US 2024/0313687 A1
(43) Pub. Date: Sep. 19, 2024

(54) MOTOR DRIVER CIRCUIT, POSITIONING DEVICE USING IT, AND HARD DISK DEVICE

(71) Applicant: ROHM Co., LTD., Kyoto (JP)

(72) Inventor: Hisashi SUGIE, Kyoto (JP)

(21) Appl. No.: 18/599,483

(22) Filed: Mar. 8, 2024

(30) Foreign Application Priority Data
Mar. 13, 2023 (JP) 2023-038908

(51) Int. Cl. H02P 27/08; G11B 19/20; H02P 25/034; H02P 25/06

(52) U.S. Cl. CPC H02P 27/085; G11B 19/20; H02P 25/034; H02P 25/06; G11B 2220/2516

(57) ABSTRACT

Provided is a motor driver circuit in which switching between a pulse width modulation mode and a linear mode is possible, the motor driver circuit including an output stage, a control circuit, a pulse width modulation drive circuit, and a linear drive circuit, in which the linear drive circuit includes a first current source driver, a first current sink driver, a second current source driver, a second current sink driver, and a differential amplifier, and current supply ability of the first current source driver and the second current source driver becomes higher than the current supply ability in normal times when a transition from the pulse width modulation mode to the linear mode is made.

### CROSS REFERENCE TO RELATED APPLICATIONS

This application claims priority benefit of Japanese Patent Application No. JP 2023-038908 filed in the Japan Patent Office on Mar. 13, 2023. Each of the above-referenced applications is hereby incorporated herein by reference in its entirety.

### BACKGROUND

The present disclosure relates to a motor driver circuit.

Linear motors (linear actuators) that position a target object are used for various pieces of electronic equipment and industrial machines. A voice coil motor is one kind of the liner motors and can control the position of a movable element according to a supplied drive current. A drive circuit of the voice coil motor executes feedback control of a current that flows in the voice coil motor, to cause the current to come close to a target current that defines a target position.

The drive system of the motor is roughly classified into the pulse width modulation (PWM) drive system and the linear drive system. The PWM drive system is excellent in efficiency although being inferior in accuracy of positioning. The linear drive system is excellent in the accuracy of positioning although having high power consumption. Among motor driver circuits, there is one in which switching between the PWM drive system and the linear drive system is possible.

An example of the related art is disclosed in Japanese Patent Laid-open No. 2020-54110.

### BRIEF DESCRIPTION OF THE DRAWINGS

FIG. 1 is a block diagram of a positioning device including a motor driver circuit according to an embodiment;

FIG. 2 is a circuit diagram illustrating a configuration example of a first linear drive circuit;

FIG. 3 is a circuit diagram illustrating a configuration example of a differential amplifier, a first current source driver, a first current sink driver, a second current source driver, and a second current sink driver;

FIG. 4 is a circuit diagram illustrating a configuration example of a current mirror circuit in which the mirror ratio can be switched;

FIG. 5 is a circuit diagram illustrating a configuration example of a first discharge circuit and a second discharge circuit;

FIG. 6 is a circuit diagram illustrating a configuration example of a second linear drive circuit;

FIG. 7 is an operation waveform diagram (simulation result) when switching from a PWM mode to a linear mode is executed;

FIG. 8 is a diagram obtained by enlarging the waveform diagram of FIG. 7;

FIG. 9 is a circuit diagram of the first current source driver and the second current source driver according to a modification example; and

FIG. 10 is a diagram illustrating a hard disk device including the motor driver circuit.

### DETAILED DESCRIPTION

### (Outline of Embodiments)

An outline of several illustrative embodiments of the present disclosure will be described. This outline explains several concepts of one or a plurality of embodiments in a simplified manner for the purpose of allowing basic understanding of the embodiments as an introduction of a detailed explanation to be described later, and does not limit the extent of the technology or the disclosure. This outline neither gives a comprehensive outline of all embodiments that are conceivable nor intends to identify important factors of all embodiments or delimit the range of a part or all of modes. For convenience, “one embodiment” is used to refer to one embodiment (embodiment example or modification example) or a plurality of embodiments (embodiment examples or modification examples) disclosed in the present specification in some cases.

A motor driver circuit according to one embodiment is a motor driver circuit in which switching between a pulse width modulation mode and a linear mode is possible. The motor driver circuit includes an output stage including a high-side transistor and a low-side transistor that are connected to a coil of a motor, a control circuit that generates a control signal to give an instruction on a drive voltage to be applied to the coil, a pulse width modulation drive circuit that becomes active in the pulse width modulation mode and generates a pulse signal having a duty cycle according to the control signal, to execute switching of the high-side transistor and the low-side transistor, and a linear drive circuit that becomes active in the linear mode and controls a gate voltage of the high-side transistor and the low-side transistor to cause the drive voltage to come close to a target voltage according to the control signal. The linear drive circuit includes a first current source driver that sources a first source current to a gate of the high-side transistor, a first current sink driver that sinks a first sink current from the gate of the high-side transistor, a second current source driver that sources a second source current to a gate of the low-side transistor, a second current sink driver that sinks a second sink current from the gate of the low-side transistor, and a differential amplifier that controls the first current source driver, the first current sink driver, the second current source driver, and the second current sink driver to cause the drive voltage to come close to the target voltage according to the control signal. The current supply ability of the first current source driver and the second current source driver becomes higher than the current supply ability in normal times when a transition from the pulse width modulation mode to the linear mode is made.

According to this mode, enhancing the current supply ability of the first current source driver/second current source driver when switching from the PWM mode to the linear mode is executed makes it possible for the gate voltage of the high-side transistor/low-side transistor to rise at high speed in the case in which the gate voltage is at the low level in the immediately prior PWM mode. This can cause the gate voltage to promptly converge on the optimum voltage level and suppress fluctuation of the output current.

In one embodiment, the first current source driver may source the first source current obtained by multiplying one of differential currents generated by the differential amplifier by a first coefficient to the gate of the high-side transistor. The first current sink driver may sink the first sink current obtained by multiplying the other of the differential currents by a second coefficient from the gate of the high-side transistor. The second current source driver may source the second source current obtained by multiplying the other of the differential currents by a third coefficient to the gate of the low-side transistor. The second current sink driver may sink the second sink current obtained by multiplying the one of the differential currents by a fourth coefficient from the gate of the low-side transistor. The first coefficient and the third coefficient may become larger than the first coefficient and the third coefficient in normal times when a transition from the pulse width modulation mode to the linear mode is made.

In one embodiment, the first current source driver may include a first current mirror circuit that returns the one of the differential currents. The second current source driver may include a second current mirror circuit that returns the other of the differential currents. The mirror ratio of the first current mirror circuit and the second current mirror circuit may be switchable.

In one embodiment, the first current source driver may include a first constant current source that becomes active when a transition from the pulse width modulation mode to the linear mode is made and sources a first auxiliary source current to the gate of the high-side transistor. The second current source driver may include a second constant current source that becomes active when a transition from the pulse width modulation mode to the linear mode is made and sources a second auxiliary source current to the gate of the low-side transistor.

In one embodiment, the linear drive circuit may further include a first discharge circuit that is connected to and between a gate and a source of the high-side transistor and is allowed to be switched on and off and a second discharge circuit connected to and between a gate and a source of the low-side transistor. The first discharge circuit and the second discharge circuit may be turned on when a transition from the pulse width modulation mode to the linear mode is made.

According to this mode, turning on the first discharge circuit and the second discharge circuit when switching from the PWM mode to the linear mode is executed makes it possible for the gate voltage of the high-side transistor/low-side transistor to lower at high speed in the case in which the gate voltage is at the high level in the immediately prior PWM mode. This can cause the gate voltage to promptly converge on the optimum voltage level and suppress fluctuation of the output current.

In one embodiment, the motor may be a linear motor. In one embodiment, the linear motor may be a voice coil motor.

In one embodiment, the motor driver circuit may be monolithically integrated on one semiconductor substrate. “Monolithically integrated” includes the case in which all of constituent elements of the circuit are formed on the semiconductor substrate and the case in which major constituent elements of the circuit are integrated, and some of resistors, capacitors, and so forth may be disposed outside the semiconductor substrate for adjustment of the circuit constant. Integrating the circuit on one chip makes it possible to reduce the circuit area and keep characteristics of circuit elements uniform.

A positioning device according to one embodiment includes a linear motor and any of the above-described motor driver circuits that drives the linear motor.

A hard disk device according to one embodiment includes the above-described positioning device.

### Embodiment

A preferred embodiment will be described below with reference to the drawings. The same or equivalent constituent elements, components, and processing illustrated in the respective drawings are given the same numeral or symbol, and overlapping description is omitted as appropriate. Moreover, the embodiment does not limit the disclosure and the technology and is an exemplification, and all characteristics described in the embodiment and combinations thereof are not necessarily essential matters of the disclosure and the technology.

In the present specification, the “state in which component A is connected to component B” includes the case in which component A and component B are directly connected physically and also the case in which component A and component B are indirectly connected with the interposition of another component that does not have a substantial influence on the electrical connection state of component A and component B or does not impair functions and effects provided by the coupling of component A and component B.

Similarly, the “state in which component C is disposed between component A and component B” includes, besides the case in which component A and component C or component B and component C are directly connected, also the case in which component A and component C or component B and component C are indirectly connected with the interposition of another component that does not have a substantial influence on the electrical connection state of the relevant components or does not impair functions and effects provided due to the coupling of the relevant components.

Further, the ordinate axis and the abscissa axis of a waveform diagram or a time chart illustrated in the present specification are made through appropriate enlargement or contraction for facilitation of understanding, and the respective waveforms illustrated are also simplified for facilitation of understanding.

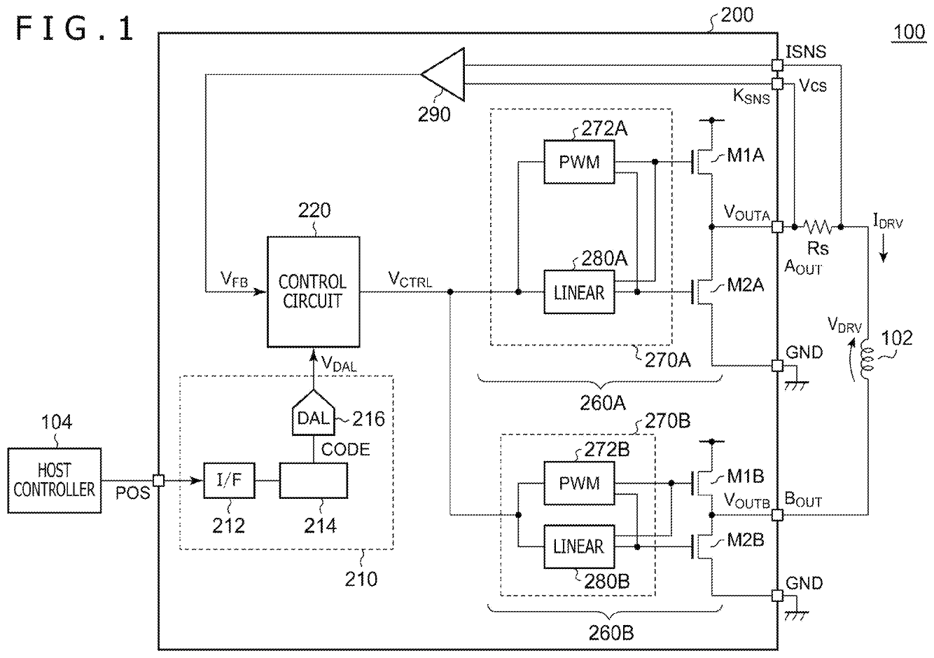

FIG. 1 is a block diagram of a positioning device 100 including a motor driver circuit 200 according to the embodiment. The positioning device 100 includes a linear motor 102, a host controller 104, and the motor driver circuit 200.

The host controller 104 comprehensively controls the positioning device 100. The host controller 104 generates a position control code POS indicating a target position of the linear motor 102 and transmits the position control code POS to the motor driver circuit 200. The host controller 104 includes a microcontroller, a field programmable gate array (FPGA), or an application specific integrated circuit (ASIC), for example.

The motor driver circuit 200 receives the position control code POS and supplies a drive current I_{DRV} with a quantity according to the position control code POS to the linear motor 102. The linear motor 102 is, for example, a voice coil motor, and a movable element thereof is displaced by a quantity according to the drive current I_{DRV} that flows in the linear motor 102.

Next, the configuration of the motor driver circuit 200 will be described. The motor driver circuit 200 includes a current command generating part 210, a control circuit 220, output stages 260A and 260B, and a current detecting circuit 290 and is a functional integrated circuit (IC) integrated on one semiconductor substrate.

The motor driver circuit 200 has two output terminals AOUT and BOUT. The linear motor 102 and a sense resistor Rs for current detection are connected to and between the first output terminal AOUT and the second output terminal BOUT. A voltage drop (current detection signal V_{CS}) proportional to the drive current I_{DRV} is generated across the sense resistor Rs. Current detection pins ISNS and KSNS are connected to the sense resistor Rs, and the current detection signal V_{CS} is input thereto.

The current command generating part 210 generates an analog command signal V_{DAC} indicating a target value of the drive circuit I_{DRV} supplied to the linear motor 102. For example, the current command generating part 210 includes an interface circuit 212, a logic circuit 214, and a digital-to-analog (D/A) converter 216. The interface circuit 212 is connected to the host controller 104 and receives control data. For example, the interface circuit 212 may be an inter IC (I²C) interface or may be a serial peripheral interface (SPI). The control data from the interface circuit 212 includes the position control code POS indicating the target position of the movable element of the linear motor 102. The logic circuit 214 outputs a control code CODE based on a received code to the D/A converter 216. The control code CODE may be the same as the position control code POS received from the host controller 104 or may be a different code obtained through computation of the position control code POS. The D/A converter 216 converts the control code CODE generated by the logic circuit 214 to the analog command signal V_{DAC}.

The configuration of the current command generating part 210 is not limited to the abovementioned one and may be a configuration that directly receives the analog command signal V_{DAC} from the external.

The current detecting circuit 290 generates a current feedback signal V_{FB} indicating the drive current I_{DRV} that flows in the linear motor 102. For example, the current feedback signal V_{FB} is represented by the following expression. k and V_{CMREF} are freely-selected constants.

$${V}_{FB} = k \times {I}_{DRV} + {V}_{C M R E F}$$

The control circuit 220 receives the current feedback signal V_{FB} and the analog command signal V_{DAC} and generates a control signal V_{CTRL}. The control signal V_{CTRL} is a command value of a drive voltage V_{DRV} that should be applied across the linear motor 102. The control circuit 220 may be configured by a digital circuit. In this case, the control circuit 220 can be configured by a combination of a proportional-integral (PI) controller (compensator), a D/A converter, an analog-to-digital (A/D) converter, and so forth. The control circuit 220 may be configured by an analog circuit. In this case, the control circuit 220 possibly includes an error amplifier.

The motor driver circuit 200 is configured to be capable of switching between a PWM mode and a linear mode.

The first output stage 260A and the second output stage 260B have a bridge-tied load (BTL) form. The first output stage 260A receives the control signal V_{CTRL} and generates a first drive voltage V_{OUTA} according to the control signal V_{CTRL} at the first output terminal AOUT. The second output stage 260B receives the control signal V_{CTRL} and generates a second drive voltage V_{OUTB} according to the control signal V_{CTRL} at the second output terminal BOUT. The first drive voltage V_{OUTA} and the second drive voltage V_{OUTB} are in opposite phases and the drive voltage V_{DRV} (=V_{OUTA}−V_{OUTB}) proportional to the control signal V_{CTRL} is applied across the linear motor 102.

The first output stage 260A includes a first high-side transistor M1A, a first low-side transistor M2A, and a first pre-driver 270A. The first high-side transistor M1A and the first low-side transistor M2A are connected in series between a power supply line and a ground line and configure a switching circuit of a push-pull type.

The first pre-driver 270A includes a first PWM circuit 272A and a first linear drive circuit 280A. The first PWM circuit 272A becomes active in the PWM mode and controls the first high-side transistor M1A and the first low-side transistor M2A to generate the pulsed first drive voltage V_{OUTA} having the duty cycle according to the control signal V_{CTRL}.

The first linear drive circuit 280A becomes active in the linear mode and controls the first high-side transistor M1A and the first low-side transistor M2A to generate the first drive voltage V_{OUTA} that linearly changes with respect to the control signal V_{CTRL}.

The second output stage 260B has a configuration similar to that of the first output stage 260A.

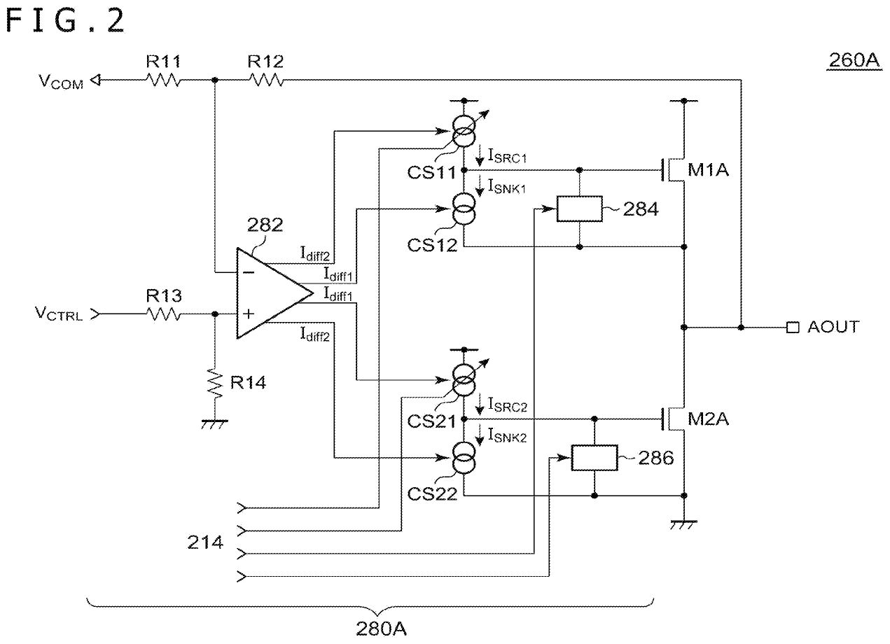

FIG. 2 is a circuit diagram illustrating a configuration example of the first linear drive circuit 280A. The first linear drive circuit 280A configures a non-inverting amplifier circuit together with the first high-side transistor M1A and the first low-side transistor M2A.

The first linear drive circuit 280A includes resistors R11, R12, R13, and R14, a differential amplifier 282, a first current source driver CS11, a first current sink driver CS12, a second current source driver CS21, a second current sink driver CS22, a first discharge circuit 284, and a second discharge circuit 286.

The first current source driver CS11 sources a first source current I_{SRC1} to the gate of the high-side transistor M1A. The first current sink driver CS12 sinks a first sink current I_{SNK1} from the gate of the high-side transistor M1A.

The second current source driver CS21 sources a second source current I_{SRC2} to the gate of the low-side transistor M2A. The second current sink driver CS22 sinks a second sink current I_{SNK2} from the gate of the low-side transistor M2A.

The resistor R11 is connected to and between the inverting input node of the differential amplifier 282 and a reference voltage node V_{COM}. The resistor R12 is connected to and between the inverting input node of the differential amplifier 282 and the first output terminal AOUT. The resistor R14 is connected to and between the non-inverting input terminal of the differential amplifier 282 and the ground. The control signal V_{CTRL} is input to the non-inverting input terminal of the differential amplifier 282 through the resistor R13. The first current source driver CS11, the first current sink driver CS12, the second current source driver CS21, and the second current sink driver CS22 operate according to differential currents I_{diff1} and I_{diff2} generated by the differential amplifier 282.

By the differential amplifier 282, the first current source driver CS11, the first current sink driver CS12, the second current source driver CS21, and the second current sink driver CS22 are controlled to cause the first drive voltage V_{OUTA} to come close to a target voltage according to the control signal V_{CTRL}.

The first current source driver CS11 and the second current source driver CS21 are each configured in such a manner that the current supply ability thereof can be switched to at least two stages. The current supply ability of the first current source driver CS11 and the second current source driver CS21 is controlled by the logic circuit 214. When a transition from the PWM mode to the linear mode is made, the logic circuit 214 makes the current supply ability of the first current source driver CS11 and the second current source driver CS21 higher than the current supply ability in normal times during a predetermined period of time (referred to also as a clamp period). For example, the predetermined period of time is several hundreds of nanoseconds to several microseconds and may be set to 1 μs, for example.

The control of the current supply ability can be executed as follows. For example, the first current source driver CS11 sources the first source current I_{SRC1} obtained by multiplying one of the differential currents generated by the differential amplifier 282, i.e., the differential current I_{diff2}, by a first coefficient K₁ to the gate of the high-side transistor M1A. Further, the first current sink driver CS12 sinks the first sink current I_{SNK1} obtained by multiplying the other of the differential currents, i.e., the differential current I_{diff1}, by a second coefficient K₂ from the gate of the high-side transistor M1A.

The second current source driver CS21 sources the second source current I_{SRC2} obtained by multiplying the other of the differential currents, i.e., the differential current I_{diff1}, by a third coefficient K₃ to the gate of the low-side transistor M2A. The second current sink driver CS22 sinks the second sink current I_{SNK2} obtained by multiplying the one of the differential currents, i.e., the differential current I_{diff2}, by a fourth coefficient K₄ from the gate of the low-side transistor M2A.

In one embodiment example, the first coefficient K₁ and the third coefficient K₃ are made larger than those in normal times when a transition from the pulse width modulation mode to the linear mode is made. This increases the current supply ability.

The first discharge circuit 284 is connected to and between the gate and the source of the first high-side transistor M1A. The second discharge circuit 286 is connected to and between the gate and the source of the first low-side transistor M2A. The first discharge circuit 284 and the second discharge circuit 286 include a voltage clamp circuit and clamp the gate-source voltage at a predetermined voltage Vclp in the on-state. The first discharge circuit 284 and the second discharge circuit 286 can be switched on and off and are controlled by the logic circuit 214. The logic circuit 214 sets the first discharge circuit 284 and the second discharge circuit 286 to the on-state during a predetermined period of time when a transition from the PWM mode to the linear mode is made. It is preferable that the predetermined voltage Vclp be set in the vicinity of the convergence range of the gate voltage in the linear mode.

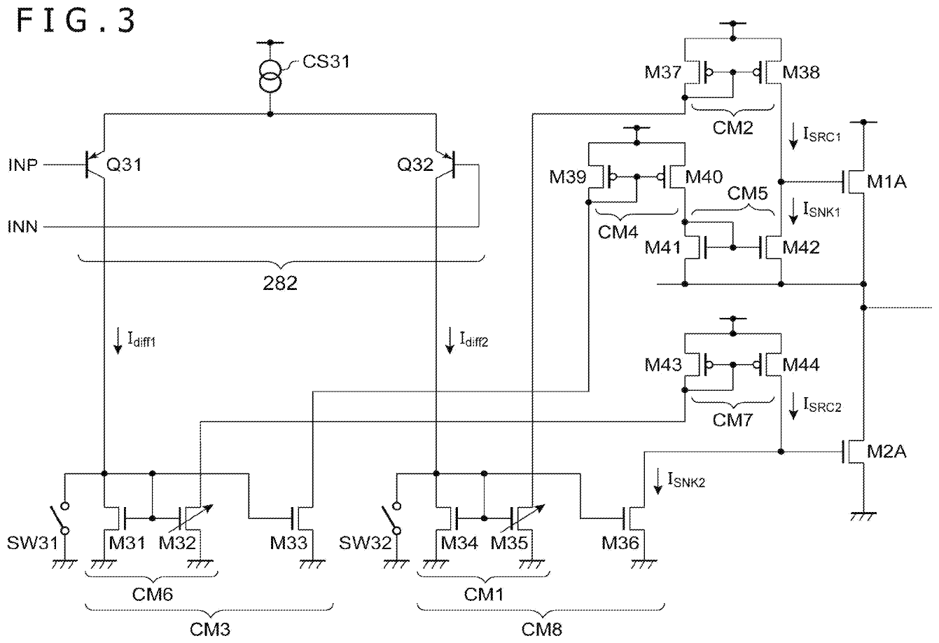

FIG. 3 is a circuit diagram illustrating a configuration example of the differential amplifier 282, the first current source driver CS11, the first current sink driver CS12, the second current source driver CS21, and the second current sink driver CS22. The differential amplifier 282 includes transistors Q31 and Q32 and a tail current source CS31.

The first current source driver CS11 includes current mirror circuits CM1 and CM2. The current mirror circuit CM1 includes transistors M34 and M35 and returns the one of the differential currents I_{diff}, i.e., the differential current I_{diff2}, generated by the differential amplifier 282. The current mirror circuit CM2 includes transistors M37 and M38 and returns the output current of the current mirror circuit CM1 to generate the first source current I_{SRC1}.

When the mirror ratios (current amplification factors) of the current mirror circuits CM1 and CM2 are defined as α1 and α2, respectively, the following expressions hold.

$${I}_{S R C 1} = {K}_{1} \times {I}_{dif 2}$$

$${K}_{1} = α 1 \times α 2$$

It suffices to make at least one of α1 and α2 variable for switching the current amplification factor K₁ as described above. In the example of FIG. 3, the configuration is made in such a manner that the effective size (gate width/gate length W/L) of the transistor M35 on the output side of the current mirror circuit CM1 is variable. Thus, α1 is variable. Further, when switching from the PWM mode to the linear mode is executed, the size of the transistor M35 becomes larger than that in normal operation during a predetermined period of time.

The first current sink driver CS12 includes current mirror circuits CM3, CM4, and CM5. The current mirror circuit CM3 includes transistors M31 and M33 and returns the other of the differential currents I_{diff}, i.e., the differential current Idiff1, generated by the differential amplifier 282. The current mirror circuit CM4 includes transistors M39 and M40 and returns the output current of the current mirror circuit CM3. The current mirror circuit CM5 includes transistors M41 and M42 and returns the output current of the current mirror circuit CM4 to generate the first sink current I_{SNK1}.

When the mirror ratios (current amplification factors) of the current mirror circuits CM3, CM4, and CM5 are defined as α3, α4, and α5, respectively, the following expressions hold.

$${I}_{S N K 1} = {K}_{2} \times {I}_{d iff 1}$$

$${K}_{2} = α 3 \times α 4 \times α 5$$

The second current source driver CS21 includes current mirror circuits CM6 and CM7. The current mirror circuit CM6 includes the transistors M31 and M32 and returns the other of the differential currents I_{diff}, i.e., the differential current I_{diff1}, generated by the differential amplifier 282. The current mirror circuit CM7 includes transistors M43 and M44 and returns the output current of the current mirror circuit CM6 to generate the second source current I_{SRC2}.

When the mirror ratios (current amplification factors) of the current mirror circuits CM6 and CM7 are defined as α6 and α7, respectively, the following expressions hold.

$${I}_{SRC 2} = {K}_{3} \times {I}_{diff 1}$$

$${K}_{3} = α 6 \times α 7$$

It suffices to make at least one of α6 and α7 variable for switching the current amplification factor K₃ as described above. In the example of FIG. 3, the configuration is made in such a manner that the effective size (gate width/gate length W/L) of the transistor M32 on the output side of the current mirror circuit CM6 is variable. Thus, α6 is variable. Further, when switching from the PWM mode to the linear mode is executed, the size of the transistor M32 becomes larger than that in normal operation during a predetermined period of time.

The second current sink driver CS22 includes a current mirror circuit CM8. The current mirror circuit CM8 includes transistors M34 and M36 and returns the one of the differential currents I_{diff}, i.e., the differential current I_{diff2}, generated by the differential amplifier 282, to generate the second sink current I_{SNK2}.

When the mirror ratio (current amplification factor) of the current mirror circuit CM8 is defined as α8, the following expressions hold.

$${I}_{SNK 2} = {K}_{4} \times {I}_{diff 2}$$

$${K}_{4} = α 8$$

The switches SW31 and SW32 are turned on in the PWM mode and are turned off in the linear mode.

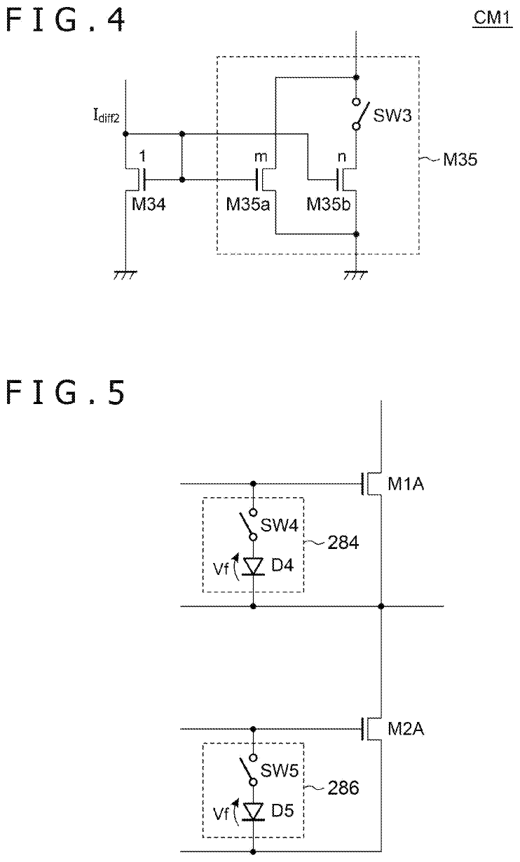

FIG. 4 is a circuit diagram illustrating a configuration example of the current mirror circuit CM1 in which the mirror ratio can be switched. The transistor M35 on the output side of the current mirror circuit CM1 includes a transistor M35a, a switch SW3 connected in parallel to the transistor M35a, and a transistor M35b. When the size ratio among the transistors M34, M35a, and M35b is defined as 1:m:n, the mirror ratio α1 when the switch SW3 is in the off-state is 1:m, and the mirror ratio α1 when the switch SW3 is in the on-state is 1:(m+n).

FIG. 5 is a circuit diagram illustrating a configuration example of the first discharge circuit 284 and the second discharge circuit 286. The first discharge circuit 284 includes a switch SW4 and a diode D4 connected in series between the gate and the source of the first high-side transistor M1A. When the switch SW4 is turned on, the charge stored at the gate of the first high-side transistor M1A is discharged, and the gate-source voltage lowers to a voltage level that depends on a forward voltage Vf of the diode D4 and is clamped.

Similarly, the second discharge circuit 286 includes a switch SW5 and a diode D5 connected in series between the gate and the source of the first low-side transistor M2A.

In FIG. 5, the diodes D4 and D5 can be replaced by a metal oxide semiconductor field effect transistor (MOSFET) whose gate and drain are connected. In this case, the gate-source voltage can be clamped at not the forward voltage Vf but a voltage that depends on a gate threshold voltage Vth of the MOSFET.

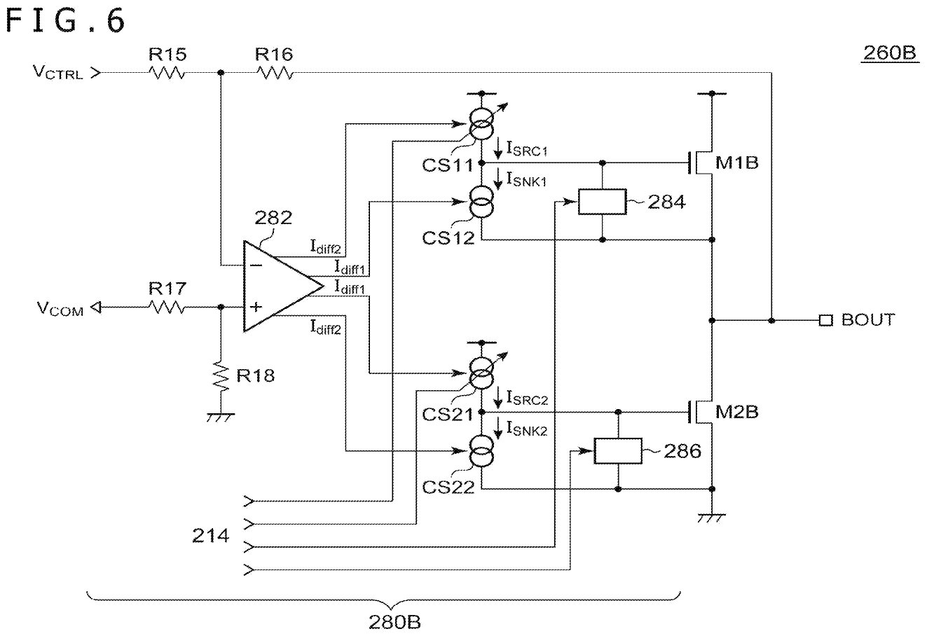

FIG. 6 is a circuit diagram illustrating a configuration example of a second linear drive circuit 280B. The second linear drive circuit 280B includes resistors R15 to R18 instead of the resistors R11 to R14 in FIG. 2. The second linear drive circuit 280B configures an inverting amplifier circuit together with a second high-side transistor M1B and a second low-side transistor M2B.

The above is the configuration of the motor driver circuit 200. Next, the operation thereof will be described.

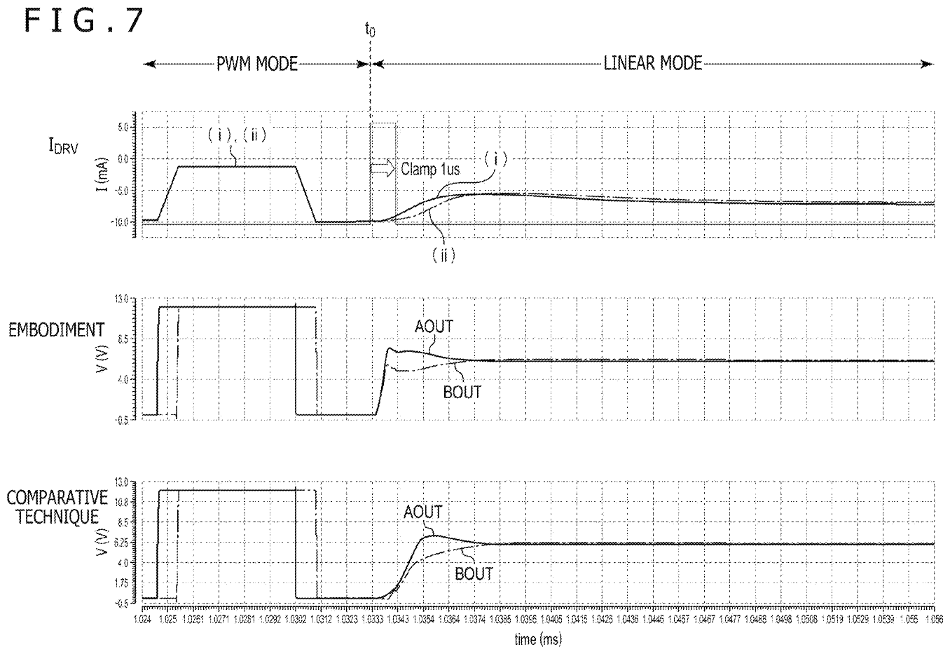

FIG. 7 is an operation waveform diagram (simulation result) when switching from the PWM mode to the linear mode is executed. An advantage of the motor driver circuit 200 according to the embodiment will be described through a comparison with a comparative technique. In a motor driver circuit according to the comparative technique, the current supply ability of the first current source driver CS11 and the second current source driver CS21 is typically constant.

The drive current I_{DRV} is illustrated at the uppermost stage of FIG. 7. (i) indicates the drive current I_{DRV} in the embodiment. (ii) indicates the drive current I_{DRV} in the comparative technique. The output voltages AOUT (V_{OUTA}) and BOUT (V_{OUTB}) in the embodiment are illustrated at the middle stage in FIG. 7. The output voltages AOUT (V_{OUTA}) and BOUT (V_{OUTB}) in the comparative technique are illustrated at the lowermost stage in FIG. 7.

A clock time t₀ represents the timing of the switching from the PWM mode to the linear mode. AOUT and BOUT are both at the low level immediately prior to the switching.

In the comparative technique, the rate of rise of the output voltages V_{OUTA} and V_{OUTB} is lower than in the embodiment. Thus, the drive current I_{DRV} gently rises toward a target level. In contrast, in the present embodiment, the rate of rise of the output voltages V_{OUTA} and V_{OUTB} is higher than that in the comparative technique. As a result, the drive current I_{DRV} can be made to rapidly converge on the target level.

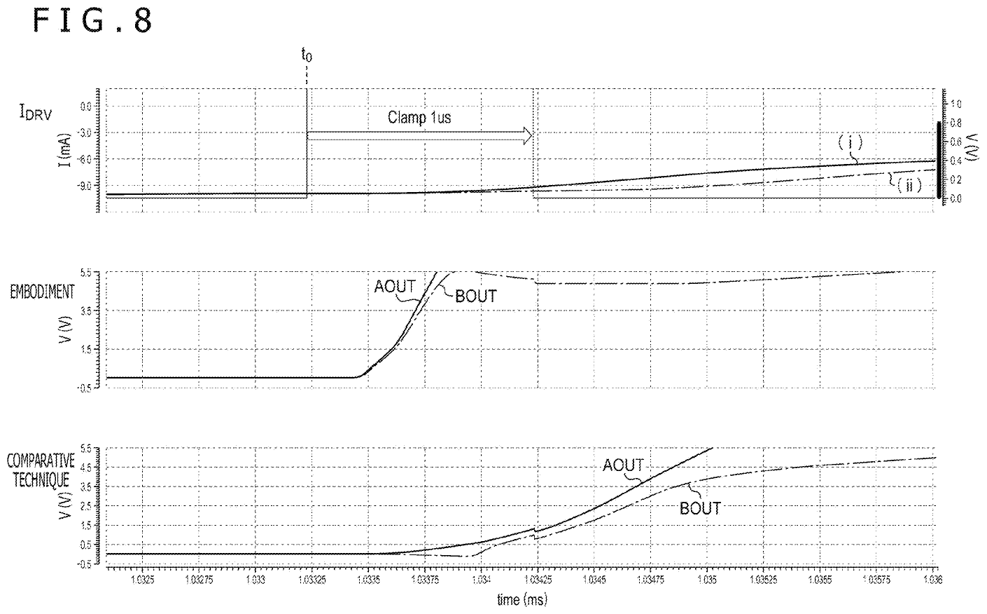

FIG. 8 is an operation waveform diagram (simulation result) when the switching from the PWM mode to the linear mode is executed. FIG. 8 is a diagram obtained by enlarging the waveform diagram of FIG. 7. Further, HGA-AOUT represents the gate-source voltage of the first high-side transistor M1A. HGB-BOUT represents the gate-source voltage of the second high-side transistor M1B. LGA represents the gate-source voltage of the first low-side transistor M2A. LGB represents the gate-source voltage of the second low-side transistor M2B.

AOUT and BOUT are both at the low level immediately prior to the mode switching at the clock time t₀. Thus, the gate-source voltages LGA and LGB of the low-side transistors M2A and M2B are both at the high level, and the gate-source voltages HGA-AOUT and HGB-BOUT of the high-side transistors M1A and M1B are both at the low level.

The gate voltage of the low-side transistors M2A and M2B lowers at high speed due to the discharge circuits 284 and 286 in both the embodiment and the comparative technique. However, in the comparative technique, the rise of the gate voltage of the high-side transistors M1A and M1B is slow. Due to this, the rise of the output voltages AOUT and BOUT is slow.

In contrast, in the present embodiment, the current supply ability of the first current source driver CS11 and the second current source driver CS21 becomes higher during the clamp period. Therefore, the rise of the gate voltage of the high-side transistors M1A and MIB becomes faster than in the comparative technique. Owing to this, the rise of the output voltages AOUT and BOUT becomes faster, and the length of time taken for the drive current I_{DRV} to converge on the target level is shortened.

Here, LGA, LGB, HGA-AOUT, and HGB-BOUT all converge on substantially the same voltage level Vclp that depends on the first discharge circuit 284 or the second discharge circuit 286. Setting this voltage level Vclp in the vicinity of the convergence range of the gate-source voltage in the linear mode makes it possible to cause the feedback control in the linear mode to converge on a stable state in a short period of time.

Next, a modification example of the motor driver circuit 200 will be described.

The method for enhancing the current supply ability of the first current source driver CS11 and the second current source driver CS21 is not limited to that described in the embodiment.

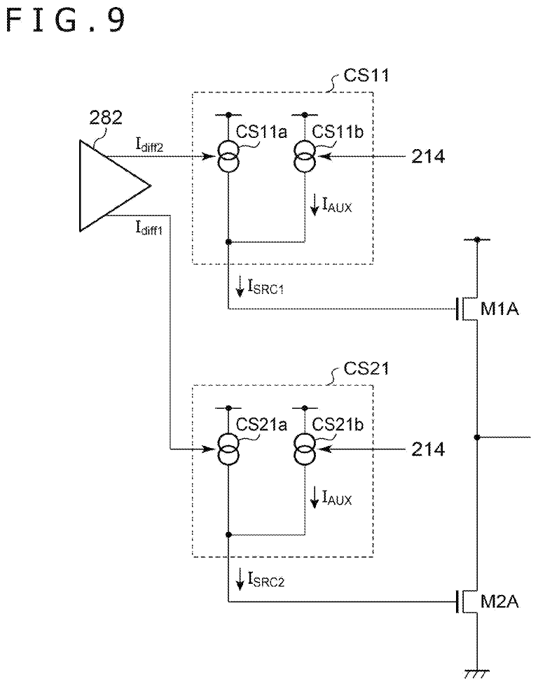

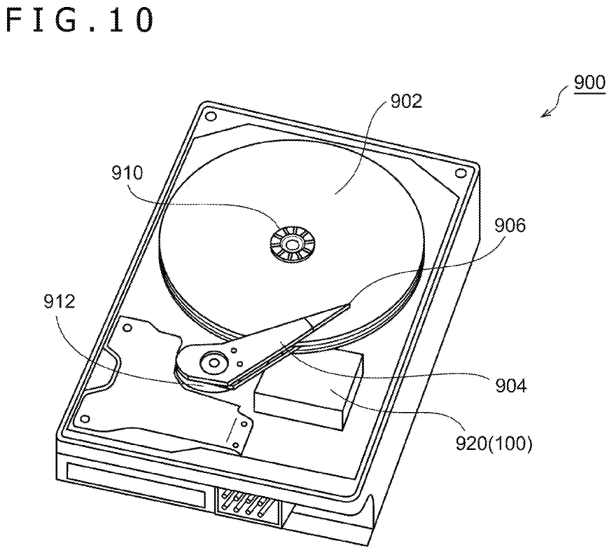

FIG. 9 is a circuit diagram of the first current source driver CS11 and the second current source driver CS21 according to a modification example. The first current source driver CS11 includes a main current source CS11a and an auxiliary current source CS11b. The main current source CS11a amplifies the differential current I_{diff2} generated by the differential amplifier 282 with a predetermined current amplification factor. The auxiliary current source CS11b is turned on to generate an auxiliary current I_{AUX} in the clamp period.

During the clamp period, the first source current I_{SRC1} becomes larger by the amount of auxiliary current I_{AUX}. As a result, the charging speed of the gate capacitance of the first high-side transistor M1A is increased, and thus, the gate voltage can be raised in a short period of time.

The second current source driver CS21 has a configuration similar to that of the first current source driver CS11.

### (Use Purpose)

FIG. 10 is a diagram illustrating a hard disk device 900 including the motor driver circuit 200. The hard disk device 900 includes a platter 902, a swing arm 904, a head 906, a spindle motor 910, a seek motor 912, and a motor driver circuit 920. The motor driver circuit 920 drives the spindle motor 910 and the seek motor 912.

The seek motor 912 is a voice coil motor. The motor driver circuit 200 according to the embodiment is incorporated in the motor driver circuit 920 and drives the seek motor 912. The seek motor 912 positions the head 906 through the swing arm 904.

In the present disclosure, the configuration and type of the linear motor that is the driving target are not particularly limited to any kind. For example, the present disclosure can be applied also to driving of a voice coil motor of a spring return system and other linear actuators. Alternatively, the motor of the driving target may be a spindle motor.

The use purpose of the positioning device 100 is also not limited to the hard disk device, and the positioning device 100 can be applied also to a positioning mechanism for a lens of a camera and so forth.

### (Notes)

The present specification discloses the following technology.

### (Item 1)

A motor driver circuit in which switching between a pulse width modulation mode and a linear mode is possible, the motor driver circuit including:
an output stage including a high-side transistor and a low-side transistor that are connected to a coil of a motor;
a control circuit that generates a control signal to give an instruction on a drive voltage to be applied to the coil;
a pulse width modulation drive circuit that becomes active in the pulse width modulation mode and generates a pulse signal having a duty cycle according to the control signal, to execute switching of the high-side transistor and the low-side transistor; and
a linear drive circuit that becomes active in the linear mode and controls a gate voltage of the high-side transistor and the low-side transistor to cause the drive voltage to come close to a target voltage according to the control signal,
in which the linear drive circuit includes
   a first current source driver that sources a first source current to a gate of the high-side transistor,
   a first current sink driver that sinks a first sink current from the gate of the high-side transistor,
   a second current source driver that sources a second source current to a gate of the low-side transistor,
   a second current sink driver that sinks a second sink current from the gate of the low-side transistor, and
   a differential amplifier that controls the first current source driver, the first current sink driver, the second current source driver, and the second current sink driver to cause the drive voltage to come close to the target voltage according to the control signal, and
   current supply ability of the first current source driver and the second current source driver becomes higher than the current supply ability in normal times when a transition from the pulse width modulation mode to the linear mode is made.

### (Item 2)

The motor driver circuit according to item 1, in which
the first current source driver sources the first source current obtained by multiplying one of differential currents generated by the differential amplifier by a first coefficient to the gate of the high-side transistor,
the first current sink driver sinks the first sink current obtained by multiplying the other of the differential currents by a second coefficient from the gate of the high-side transistor,
the second current source driver sources the second source current obtained by multiplying the other of the differential currents by a third coefficient to the gate of the low-side transistor,
the second current sink driver sinks the second sink current obtained by multiplying the one of the differential currents by a fourth coefficient from the gate of the low-side transistor, and
the first coefficient and the third coefficient become larger than the first coefficient and the third coefficient in normal times when a transition from the pulse width modulation mode to the linear mode is made.

### (Item 3)

The motor driver circuit according to item 2, in which
the first current source driver includes a first current mirror circuit that returns the one of the differential currents,
the second current source driver includes a second current mirror circuit that returns the other of the differential currents, and
a mirror ratio of the first current mirror circuit and the second current mirror circuit is switchable.

### (Item 4)

The motor driver circuit according to item 1, in which
the first current source driver includes a first constant current source that becomes active when a transition from the pulse width modulation mode to the linear mode is made and that sources a first auxiliary source current to the gate of the high-side transistor, and
the second current source driver includes a second constant current source that becomes active when a transition from the pulse width modulation mode to the linear mode is made and that sources a second auxiliary source current to the gate of the low-side transistor.

### (Item 5)

The motor driver circuit according to any one of items 1 through 4, in which
the linear drive circuit further includes
   a first discharge circuit that is connected to and between a gate and a source of the high-side transistor and is allowed to be switched on and off, and
   a second discharge circuit connected to and between a gate and a source of the low-side transistor, and
the first discharge circuit and the second discharge circuit are turned on when a transition from the pulse width modulation mode to the linear mode is made.

### (Item 6)

The motor driver circuit according to any one of items (1) through 5), in which
the motor is a linear motor.

### (Item 7)

The motor driver circuit according to item 6, in which
the linear motor is a voice coil motor.

### (Item 8)

The motor driver circuit according to any one of items (1) through (7), in which
the motor driver circuit is monolithically integrated on one semiconductor substrate.

### (Item 9)

A positioning device including:
a linear motor; and
the motor driver circuit according to any one of items (1) through (8), the motor driver circuit driving the linear motor.

### (Item 10)

A hard disk device including:
the positioning device according to claim 9.

According to a certain mode of the present disclosure, the followability of the output current when switching from the PWM drive system to the linear drive system is executed can be improved.

It should be understood by those skilled in the art that various modifications, combinations, sub-combinations and alterations may occur depending on design requirements and other factors insofar as they are within the scope of the appended claims or the equivalents thereof.

What is claimed is:

1. A motor driver circuit in which switching between a pulse width modulation mode and a linear mode is possible, the motor driver circuit comprising:
an output stage including a high-side transistor and a low-side transistor that are connected to a coil of a motor;
a control circuit that generates a control signal to give an instruction on a drive voltage to be applied to the coil;
a pulse width modulation drive circuit that becomes active in the pulse width modulation mode and generates a pulse signal having a duty cycle according to the control signal, to execute switching of the high-side transistor and the low-side transistor; and
a linear drive circuit that becomes active in the linear mode and controls a gate voltage of the high-side transistor and the low-side transistor to cause the drive voltage to come close to a target voltage according to the control signal,
wherein the linear drive circuit includes
a first current source driver that sources a first source current to a gate of the high-side transistor,
a first current sink driver that sinks a first sink current from the gate of the high-side transistor,
a second current source driver that sources a second source current to a gate of the low-side transistor,
a second current sink driver that sinks a second sink current from the gate of the low-side transistor, and
a differential amplifier that controls the first current source driver, the first current sink driver, the second current source driver, and the second current sink driver to cause the drive voltage to come close to the target voltage according to the control signal, and
current supply ability of the first current source driver and the second current source driver becomes higher than the current supply ability in normal times when a transition from the pulse width modulation mode to the linear mode is made.

2. The motor driver circuit according to claim 1, wherein
the first current source driver sources the first source current obtained by multiplying one of differential currents generated by the differential amplifier by a first coefficient to the gate of the high-side transistor,
the first current sink driver sinks the first sink current obtained by multiplying the other of the differential currents by a second coefficient from the gate of the high-side transistor,
the second current source driver sources the second source current obtained by multiplying the other of the differential currents by a third coefficient to the gate of the low-side transistor,
the second current sink driver sinks the second sink current obtained by multiplying the one of the differential currents by a fourth coefficient from the gate of the low-side transistor, and
the first coefficient and the third coefficient become larger than the first coefficient and the third coefficient in normal times when the transition from the pulse width modulation mode to the linear mode is made.

3. The motor driver circuit according to claim 2, wherein
the first current source driver includes a first current mirror circuit that returns the one of the differential currents,
the second current source driver includes a second current mirror circuit that returns the other of the differential currents, and
a mirror ratio of the first current mirror circuit and the second current mirror circuit is switchable.

4. The motor driver circuit according to claim 1, wherein
the first current source driver includes a first constant current source that becomes active when the transition from the pulse width modulation mode to the linear mode is made and that sources a first auxiliary source current to the gate of the high-side transistor, and
the second current source driver includes a second constant current source that becomes active when the transition from the pulse width modulation mode to the linear mode is made and that sources a second auxiliary source current to the gate of the low-side transistor.

5. The motor driver circuit according to claim 1, wherein
the linear drive circuit further includes
a first discharge circuit that is connected to and between a gate and a source of the high-side transistor and is allowed to be switched on and off, and
a second discharge circuit connected to and between a gate and a source of the low-side transistor, and
the first discharge circuit and the second discharge circuit are turned on when the transition from the pulse width modulation mode to the linear mode is made.

6. The motor driver circuit according to claim 1, wherein
the motor is a linear motor.

7. The motor driver circuit according to claim 6, wherein
the linear motor is a voice coil motor.

8. The motor driver circuit according to claim 1, wherein
the motor driver circuit is monolithically integrated on one semiconductor substrate.

9. A positioning device comprising:
a linear motor; and
the motor driver circuit according to claim 1, the motor driver circuit driving the linear motor.

10. A hard disk device comprising:
the positioning device according to claim 9.
